(19) United States
(12) Patent Application Publication
(10) Pub. No.: US 2022/0129905 A1
(43) Pub. Date: Apr. 28, 2022

(54) AGENT CONSOLE FOR FACILITATING ASSISTED CUSTOMER ENGAGEMENT

(71) Applicant: [24]7.ai, Inc., San Jose, CA (US)

(72) Inventors: Subha Sethumadhavan, Bangalore (IN); Bhanu Anupama Atmuri, Bangalore (IN); Vandana Abraham, Bangalore (IN)

(21) Appl. No.: 16/812,585

(22) Filed: Mar. 9, 2020

Related U.S. Application Data
(60) Provisional application No. 62/815,664, filed on Mar. 8, 2019.

(51) Int. Cl. G06Q 30/00; G06Q 30/02; H04L 51/02; G06N 20/00

(52) U.S. Cl. CPC G06Q 30/016; G06N 20/00; H04L 51/02; G06Q 30/0202

(57) ABSTRACT

An agent console provides interaction context derived from a plurality of enterprise interaction channels to an agent and, as a result, the agent is better equipped to handle customer queries when the chat interaction is initiated. In some cases, a proactive invite, which is provisioned to an online customer to start a chat is passed back to the agent in the agent console when the chat is directed to the agent. The proactive invite may also be enriched with information related to the reason why the particular customer qualified as a potential hot lead for provisioning of a proactive invite. The proactive invite along with the customer qualifying reason may provide the agent with the necessary context to better assist the customer.

### I. CROSS REFERENCE TO RELATED APPLICATION

This application claims the benefit of U.S. Provisional Application No. 62/815,664 filed Mar. 8, 2019, the contents of which are herein incorporated by reference.

### II. TECHNICAL FIELD

The present technology generally relates to solutions facilitating interactions between agents and customers of an enterprise, and more particularly to agent consoles capable of facilitating chat interactions between the agents and the customers of the enterprise.

### III. BACKGROUND

Most enterprises, nowadays, deploy both live and automated conversational agents to interact with existing and potential customers of the enterprises and provide them with desired assistance. The customers may initiate interactions with the conversational agents for a variety of reasons. For example, a customer may initiate a voice interaction with a conversational agent to troubleshoot a problem, to enquire about product or service of interest, to make a payment or to lodge a complaint, etc.

In some example scenarios, the conversational agents may also initiate interactions with the customers. For example, a conversational agent may initiate an interaction with a customer to offer assistance during a customer journey on an enterprise interaction channel, to provide recommendations on potential purchases, to offer promotional schemes or to offer discount coupons on latest enterprise offerings, and the like.

One example of a conversational agent is a human chat agent, who is trained to chat with visitors (i.e. with potential or existing customers) browsing an enterprise Website and provide the visitors with desired assistance. Typically, the electronic devices of the chat agents are equipped with a chat application capable of displaying a chat console to the respective agents. The chat consoles enable the respective agents to engage in chat interactions with the customers. The conventional chat console includes several content portions, which can help an agent to respond to customer queries. However, the conventional chat consoles used by the chat agents have several limitations.

In an illustrative example, a customer browsing Web pages of an enterprise Web site may be offered a chat invite to chat with a customer and receive assistance in completing a purchase transaction. If the customer accepts the chat invite, the customer is connected to an agent to engage in a chat interaction and receive the desired assistance. The agent, however, is not aware of the context of the interaction when the chat is initiated, as the conventional chat console serves as a passive medium for only facilitating chat interactions with the customers. As a result, the agent engages with the customer to first learn the context and thereafter provide the desired assistance, which may not be an efficient use of agent's and the customer's time. In some cases, the agent may ask several questions to understand the customer's concern and the customer may get frustrated on account of having to respond to the questions. In some cases, the customer may even abandon the chat interaction.

The conventional chat consoles also do not facilitate intent driven engagement. For example, typically an intention of a customer is identified or predicted during the course of the chat interaction with the agent. As a result, any recognition of intent by the agent is incidental and is with agents understanding. Further, no processing of the intent is performed in real-time to support the agent. For example, the agent may have to manually sift through all content portions available in a conventional chat console to identify content relevant for an identified intention of the customer so as to respond appropriately to a customer query, which may be cumbersome for the agent.

Furthermore, agents typically have to manually prepare wrap-up notes after completion of each chat interaction, which is burdensome for the agent as the agent may have participated in several chats during the course of the day. The conventional chat consoles do not provide any assistance to the agent in preparing wrap-up dispositions.

Accordingly, there is a need to provide assistance to the agent involved in customer engagement. It would be advantageous to provide the agent with an agent console capable of providing interaction context and facilitating intent-driven engagement to better assist the customers.

### DESCRIPTION OF THE DRAWINGS

The advantages and features of the present technology will become better understood with reference to the detailed description taken in conjunction with the accompanying drawings, wherein like elements are identified with like symbols, and in which:

FIG. 1 is a representation showing a human chat agent engaged in a chat interaction with a customer of an enterprise, in accordance with an example embodiment;

FIG. 2 is a block diagram of a system configured to facilitate chat interactions between agents and a plurality of customers of the enterprise, in accordance with an example embodiment;

FIG. 3 shows a representation of a content portion associated with an agent console, in accordance with an example embodiment;

FIG. 4 shows a representation of an agent console for illustrating intent-driven engagement facilitated by the agent console, in accordance with an example embodiment;

FIG. 5 shows another representation of the agent console of FIG. 4 for illustrating collaborative tagging of chat content by the agent, in accordance with an example embodiment; and

FIG. 6 shows an example representation of an agent console for illustrating an adding of a response as a smart response, in accordance with an example embodiment.

The drawings referred to in this description are not to be understood as being drawn to scale except if specifically noted, and such drawings are only exemplary in nature.

### DESCRIPTION OF THE TECHNOLOGY

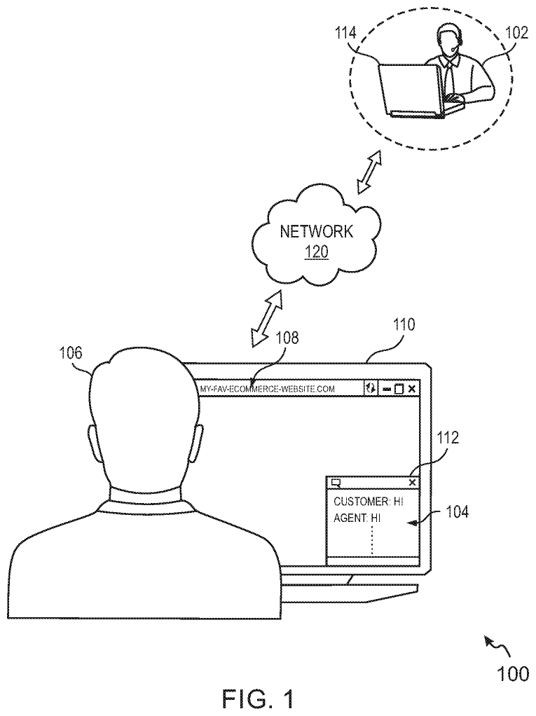

The best and other modes for carrying out the present invention are presented in terms of the embodiments, herein depicted in FIGS. 1 to 6. The embodiments are described herein for illustrative purposes and are subject to many variations. It is understood that various omissions and substitutions of equivalents are contemplated as circumstances may suggest or render expedient but are intended to cover the application or implementation without departing from the spirit or scope of the present invention. Further, it is to be understood that the phraseology and terminology employed herein are for the purpose of the description and should not be regarded as limiting. Any heading utilized within this description is for convenience only and has no legal or limiting effect.

The terms “a” and “an” herein do not denote a limitation of quantity, but rather denote the presence of at least one of the referenced items.

### Overview

Most enterprises, nowadays, deploy dedicated personnel to assist their customers. Such personnel are referred to herein as customer service representatives, customer support representatives or simply as ‘agents’ of the enterprise. The agents may engage with the customers using several interaction mediums, such as for example a voice medium, a chat medium, a social interaction medium, and the like. Human agents engaged in providing chat-based support typically use a chat console for engaging in chat interactions with the customers. The chat console includes several content portions which display content such as for example, customer journey on an enterprise interaction channel, customer interaction history, standard or canned responses to customer queries, and the like. However, the conventional chat consoles have several limitations. For example, the conventional chat consoles do not provide agents with any context of the interaction and the agents have to learn the context during the respective chat interactions with the customers. Moreover, the conventional chat consoles do not facilitate intent-driven engagement, as no processing of intent is performed in real-time.

Accordingly, an improved chat console, hereinafter referred to as an ‘agent console’ is disclosed. The agent console is capable of providing interaction context derived from a plurality of enterprise interaction channels to the agent and, as a result, the agent is far more equipped to handle customer queries when the chat interaction is initiated. In some cases, proactive invite, which is provisioned to an online customer to start a chat is passed back to the agent in the agent console when the chat is directed to the agent. The proactive invite may also be enriched with information related to the reason why the particular customer qualified as a potential hot lead for provisioning of a proactive invite. The proactive invite along with the customer qualifying reason may provide the agent with the necessary context to better assist the customer.

Further, the agent console allows the agent to collaboratively tag conversational lines in the chat interaction. For example, the agent may tag a conversational line as an ‘intent’ of the customer (i.e. the intention of the customer for engaging in the chat interaction). In at least one example embodiment, upon identification of the intent, the several content portions of the agent console may dynamically be refreshed to only display content relevant to the identified intent. As a result, of such dynamic processing of the intent in real-time, the agent is spared the effort of manually sifting through several content portions to identify relevant content. In an illustrative example, workflow steps (i.e. steps to be performed by an agent for a given chat interaction), canned responses, enterprise integrations, may all be updated as per the intent to assist the agent in engaging with the customer, effectively. It is noted that the intent may also be identified or predicted based on the customer journey or customer's previous interactions and such identified/predicted intent may be passed on to the agent in the agent console, which may then cause dynamic refresh of the content portions being displayed to the agent.

Furthermore, using the tagged conversational lines, the agent console may be configured to automatically generate wrap-up dispositions, thereby precluding the agent to prepare a wrap-up summary for each completed chat interaction. The agent console is further explained in detail with reference to FIGS. 1 to 6 hereinafter.

FIG. 1 is a representation 100 showing a human chat agent 102 engaged in a chat interaction 104 with a customer 106 of an enterprise, in accordance with an example embodiment. The term ‘enterprise’ as used herein may relate to any private or public entity offering products, services and/or information to consumers of such offerings. For example, the enterprise may be a retail enterprise, a banking enterprise, a news channel, an educational institution, a financial trading enterprise, an aviation company, a consumer goods business, and the like. Most enterprises, nowadays, deploy personnel dedicated to providing assistance to the customers. Such personnel are referred to herein as ‘conversational agents’. One such example conversational agent is shown as human chat agent 102 in FIG. 1. The human chat agent 102 is hereinafter referred to as agent 102.

The customer 106 is shown to be accessing an enterprise Website 108 using an electronic device 110 (exemplarily depicted to be a desktop computer). It is noted that the Website 108 is depicted to be devoid of content for illustration purposes and that the Website 108 may display content related to enterprise offerings, promotional schemes, new launches, and the like. Further, the Website 108 may display a widget or a pop-up (not shown in FIG. 1), which is associated with text such as ‘Let's Chat’ or ‘Need Assistance, Click Here!’. The customer 106 may click on the widget or the pop-up to seek assistance. It is noted the customer 106 may seek assistance from an agent, such as the agent 102, for a variety of reasons, such as to troubleshoot a problem, to enquire about a product or a service of interest, to make a payment, to lodge a complaint, and the like.

Upon receiving an input corresponding to the widget or the pop-up, a Web server hosting the Web site 108 may be configured to cause display of a chat console such as a chat console 112 on the display screen of the customer's electronic device 110. The chat console is hereinafter referred to as a customer chat console 112. The customer 106 may use the customer chat console 112 to engage in a textual chat conversation (i.e. the chat interaction 104) with the agent 102, for receiving desired assistance.

The agent 102 is also depicted to utilize an electronic device 114 (exemplarily depicted to be a laptop) for interacting with customers, such as the customer 106. The electronic devices 110 and 114 are configured to connect to a communication network, such as a network 120, for facilitating the chat interaction between the customer 106 and the agent 102. Examples of the network 120 may include wired networks, wireless networks or a combination thereof. Some non-exhaustive examples of the wired networks may include Ethernet, local area network (LAN), fiber-optic cable network, and the like. Some non-exhaustive examples of the wireless networks may include cellular networks like GSM/3G/4G/5G/CDMA networks, wireless LAN, Blue-tooth or ZigBee networks, and the like. An example of a combination of wired and wireless networks may include the Internet.

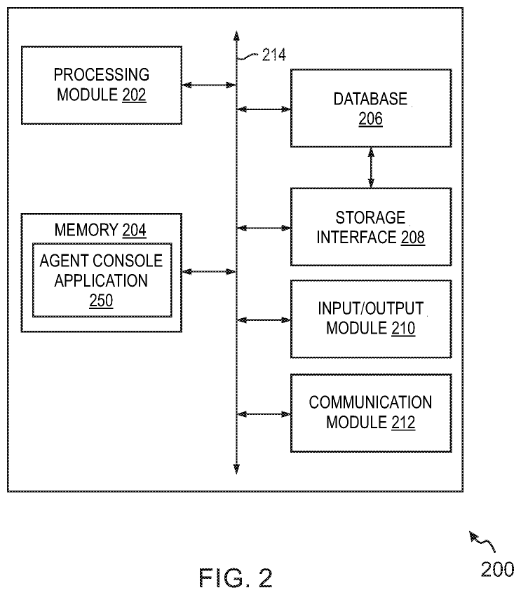

In at least one example embodiment, the electronic device 114 is configured to display a chat console, referred to herein as an agent console, for enabling the agent 102 to engage in the chat interaction 104 with the customer 106. The agent console is capable of assisting the agent, such as by providing omni-channel interaction context, by sharing proactive invites along with lead qualifying information, by facilitating collaborative tagging of content and by facilitating intent-driven engagement, and the like, to facilitate the chat interaction 104 with the customer 106. In at least one embodiment, a system is configured to cause display of such agent consoles on the electronic devices of the agents to facilitate agent chat interactions with the customers. The system for facilitating chat interactions with the customers is explained next with reference to FIG. 2.

FIG. 2 is a block diagram of a system 200 configured to facilitate chat interactions between the agents (such as the agent 102 shown in FIG. 1) and a plurality of customers of the enterprise, in accordance with an example embodiment.

In one embodiment, the system 200 may be implemented as an interaction platform including a set of software layers on top of existing hardware systems. In another embodiment, the system 200 may be implemented completely as a platform including a mix of existing open systems, proprietary systems and third-party systems.

In one embodiment, the system 200 is included within an enterprise server. The enterprise server may be deployed either at an enterprise site, at a site associated with a customer service center, on the cloud or at any other remote location. The electronic devices associated with the agents may be configured to access the enterprise server using a wired connection (for example, a LAN connection), a wireless connection (for example, a WLAN connection) or a combination of wired and wireless connections (for example, the Internet).

The system 200 includes a processing module 202, a memory 204, a database 206, a storage interface 208, an input/output (I/O) module 210 and a communication module 212. It is noted that although the system 200 is depicted to include the processing module 202, the memory 204, the database 206, the storage interface 208, the input/output (I/O) module 210 and the communication module 212, in some embodiments, the system 200 may include more or fewer components than those depicted herein. More specifically, the system 200 may be implemented as a centralized system, or, alternatively, the various components of the system 200 may be deployed in a distributed manner while being operatively coupled to each other. For example, in at least some embodiments, the database 206 may not be a part of the system 200 but instead be deployed as a data store in an external environment, such as in a remote Web server or in cloud storage and may be in operable communication with the system 200. In an embodiment, one or more functionalities of the system 200 may also be embodied as a client within electronic devices, such as agents' electronic devices. In another embodiment, the system 200 may be a central system that is shared by or accessible to each of such devices.

The processing module 202 may be embodied as a multi-core processor, a single core processor, or a combination of one or more multi-core processors and one or more single core processors. For example, the processing module 202 may be embodied as one or more of various processing devices, such as a coprocessor, a microprocessor, a controller, a digital signal processor, a processing circuitry with or without an accompanying digital signal processor, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processing module 202 may be configured to execute hard-coded functionality. In an embodiment, the processing module 202 is embodied as an executor of software instructions, wherein the instructions may specifically configure the processing module 202 to perform the algorithms and/or operations described herein when the instructions are executed.

In an embodiment, the memory 204 is capable of storing machine executable instructions, referred to herein as platform instructions. The processing module 202 may be configured to execute the platform instructions. The memory 204 may be embodied as one or more volatile memory devices, one or more non-volatile memory devices, and/or a combination of one or more volatile memory devices and non-volatile memory devices. For example, the memory 204 may be embodied as magnetic storage devices (such as hard disk drives, floppy disks, magnetic tapes, etc.), optical magnetic storage devices (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). In at least one example embodiment, the memory 204 stores an agent console application 250. The processing module 202 executes instructions related to the agent console application 250 stored in the memory 204 to cause display of an agent console on respective electronic devices of the agents as will be explained in further detail later.

The database 206 is any computer-operated hardware suitable for storing data related to the customers of the enterprise. For example, the database 206 may include a CRM database capable of storing information related to each customer such as the customer's name, customer's contact information, the type of electronic devices associated with the customer, recent customer purchase transaction, recent journey information on the enterprise interaction channels, and the like. The processing module 202 may be configured to fetch information for customers engaged in chat interactions from the CRM database stored in the database 206. Similarly, the database 206 may include a billing database, a ticketing database, and the like, and the processing module 202 may be configured to fetch customer information from the respective databases in the database 206.

The database 206 may include multiple storage units such as hard disks and/or solid-state disks in a redundant array of inexpensive disks (RAID) configuration. The database 206 may include a storage area network (SAN) and/or a network attached storage (NAS) system. The storage interface 208 is any component capable of providing the processing module 202 with access to the database 206. The storage interface 208 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processing module 202 with access to the database 206.

In an embodiment, the I/O module 210 includes mechanisms configured to receive inputs from and provide outputs to the users of the system 200. The term ‘users of the system 200’ as used herein may include an agent of the enterprise (such as the agent 102 shown in FIG. 1), an IT manager of the enterprise, a local system administrator, and the like. To enable reception of inputs and provide outputs to the user of the system 200, the I/O module 210 may include at least one input interface and/or at least one output interface. Examples of the input interface may include, but are not limited to, a keyboard, a mouse, a joystick, a keypad, a touch screen, soft keys, a microphone, and the like. In at least one embodiment, the user of the system 200, such as the agent may use the input interface to access the agent console application 250 and customize the agent console for respective need. For example, the agent may specify one or more enterprise system applications that the agent typically uses. In an illustrative example, the agent may specialize in resolving customer's billing related concerns. In such a scenario, the agent may require access to enterprise system applications like the CRM application, the billing application, the ticketing application, frequently. Accordingly, the agent may specify such applications using the I/O module 210 to customize the agent console.

Examples of the output interface of the I/O module 210 may include, but are not limited to, a display such as a light emitting diode display, a thin-film transistor (TFT) display, a liquid crystal display, an active-matrix organic light-emitting diode (AMOLED) display, a microphone, a speaker, a ringer, a vibrator, and the like. In an example embodiment, at least one module of the system 200 may include I/O circuitry configured to control at least some functions of one or more elements of the I/O module 210, such as, for example, a speaker, a microphone, a display, and/or the like. The module of the system 200 and/or the I/O circuitry may be configured to control one or more functions of the one or more elements of the I/O module 210 through computer program instructions, for example, software and/or firmware, stored on a memory, for example, the memory 204, and/or the like, accessible to the processing module 202 of the system 200.

The communication module 212 is configured to facilitate communication between the system 200 and one or more remote entities over a communication network. For example, the communication module 212 is capable of facilitating agent access to the system 200. The agents, as explained above, may access the system 200 to utilize the agent console for engaging in chat interactions with the customers. In some embodiments, the agents may access the system 200 using the communication module 212 and download an instance of the agent console application 250 onto their respective electronic devices.

In an embodiment, various components of the system 200, such as the processing module 202, the memory 204, the database 206, the storage interface 208, the I/O module 210 and the communication module 212 are configured to communicate with each other via or through a centralized circuit system 214. The centralized circuit system 214 may be various devices configured to, among other things, provide or enable communication between the components (202-212) of the system 200. In certain embodiments, the centralized circuit system 214 may be a central printed circuit board (PCB) such as a motherboard, a main board, a system board, or a logic board. The centralized circuit system 214 may also, or alternatively, include other printed circuit assemblies (PCAs) or communication channel media.

In at least some embodiments, the agent console application 250 is configured to generate an agent console capable of assisting the agents in engaging with customers of the enterprise using the chat medium. As explained above, the electronic devices associated with the agents may be configured to access the agent console application 250 stored in the system 200. In some embodiments, instances of the agent console application 250 may be downloaded from the enterprise server, i.e. from the system 200, as a client onto the respective electronic devices. The agents may thereafter install the downloaded client of the agent console application 250 onto their respective electronic devices. The downloaded client may be in operable communication with the agent console application 250 stored in the system 200.

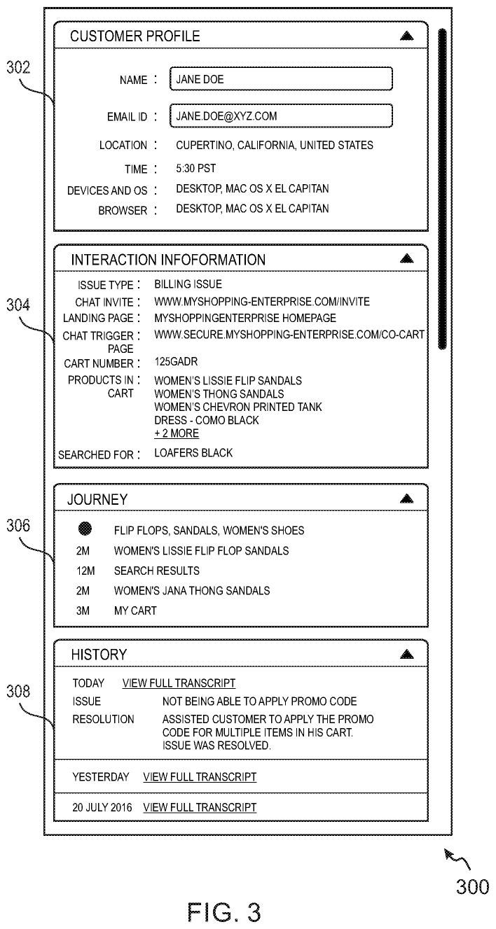

The agent console application 250, when accessed by the agent, may be configured to cause display of a UI associated with the agent console. The UI associated with the agent console may include a plurality of content portions in addition to a chat interaction panel. One such content portion is shown in FIG. 3.

FIG. 3 shows a representation of a content portion 300 associated with an agent console, in accordance with an example embodiment. The content portion 300 as depicted in FIG. 3, corresponds to a part of a UI associated with the agent console displayed to the agent for engaging in the chat interaction with the customer. In at least one example embodiment, the processing module 202 executing the instructions associated with the agent console application 250 is configured to communicate with relevant data stores using API calls to fetch information related to the customer from a CRM database, and information related to the customer's journey from a Web server hosting the enterprise website, and dynamically populate the information in the content portion 300 of the agent console. The content portion 300 is hereinafter referred to as portion 300.

The conventional agent consoles do not provide interaction context to the agent. As a result, the agent is unaware of the reason why the customer has decided to engage in a chat interaction with the agent. The agent console as configured by the processing module 202 by executing the instructions associated with the agent console application 250 provides omnichannel context, or more specifically, a contextual awareness of the customer's activity across a plurality of enterprise interaction channels to the agent. As a result, the agent is better equipped to handle a customer query when the customer initiates an interaction with the agent. The omnichannel context precludes the need for the agent to interact with the agent to learn context, thereby improving a quality of interaction experience afforded to the customer.

To that effect, the portion 300 is depicted to include a plurality of widgets, such as a widget 302, a widget 304, a widget 306 and a widget 308. The widget 302 is associated with a title ‘CUSTOMER PROFILE’ and includes a plurality of form fields showing information related to the customer's name, Email ID, location, current time, customer's electronic device, operating system and a browser (i.e. OS and browser installed in the electronic device). The widget 304 is associated with a title ‘INTERACTION INFORMATION’ and is configured to display information related to the type of issue that the customer is facing, on which Web page of the enterprise Website a chat invite was provisioned to the customer, what products are currently added to a shopping cart, what has the customer recently searched for (for example, the customer is depicted to have recently searched for ‘loafers’), and the like.

The widget 306 is associated with a title ‘JOURNEY’ and includes a listing of Web pages visited by the customer during a current journey on the enterprise Website. Furthermore, a time stamp is associated with each entry in the listing, to enable the agent to not only learn the Web pages visited by the customer, but also a sequence of Web page visits and the amount of time spent on each Web page. The widget 308 is associated with a title ‘HISTORY’ and displays information related to previous interactions involving the customer along with corresponding transcripts.

The identification of the issue type, i.e. ‘Billing issue’, as shown in widget 304 enables the agent to learn the context of why the customer wishes to engage in a chat interaction with the agent. Moreover, the context is also updated in real-time and provided to the agent within the chat interaction panel itself. Such presentation of real-time context within the chat interaction panel is also referred to as ‘in-line context’. For example, in addition to the information related to current journey and previous journeys as outlined in the widgets 306 and 308, the real-time change in context is also forwarded by the processing module 202 to the agent. In an illustrative example, the customer during the course of interaction with the agent may continue browsing on the enterprise Website. The journey of the customer on the enterprise Website even during the course the chat interaction may also be relayed to the agent. For example, a message such as for example, ‘JANE DOE HAS MOVED FROM THE PLANS PAGE TO THE CARDS PAGE’, may be conveyed to the agent in the agent console so as to provide real-time context to the agent.

Thus, the agent console functions as an active assistant in customer engagement as opposed to a passive medium for facilitating chat interactions as served by the current chat consoles. It is noted that the information depicted in the portion 300 should not be considered to be limiting the scope of the invention. It is understood that the agent may be provided with content of any type or form that may enable the agent in providing better assistance to the customer. In one illustrative example, a customer may be browsing Web pages related to hotel accommodations. Based on the processing of the browsing data, the processing module 202 may predict an intention of the customer to rent a hotel room. If a predicted intention of the customer is associated with a confidence score greater than a predefined threshold (for example, 0.75 or 75%), then the processing module 202 may proactively send a chat invite to the customer for offering assistance in booking a hotel room. In at least one example embodiment, the processing module 202 may also forward the proactive chat invite to the agent in the agent console subsequent to the acceptance of the chat invite by the customer. The agent is therefore aware of the context, and instead of asking ‘How may I help you today?’, the agent can directly offer assistance, such as for example by stating: ‘May I help you book a reservation for this room?’, thereby greatly improving a customer satisfaction (CSAT) score.

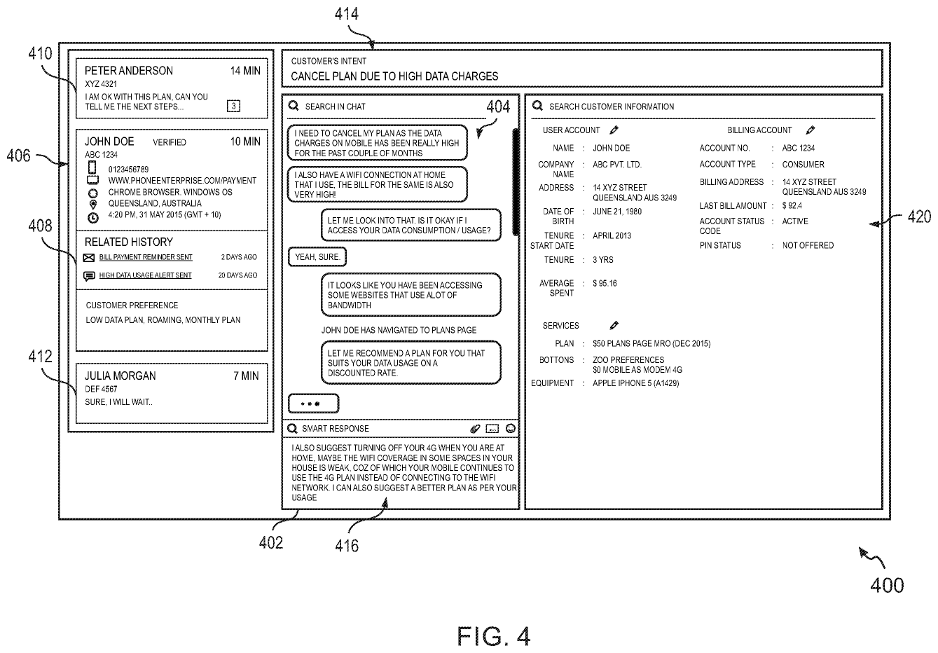

The processing module 202 of the system 200 (shown in FIG. 2) may also be configured to facilitate intent-driven engagement for customer interactions. For example, the processing module 202 may predict an intention of the customer based on current and/or past journeys of the customer on the enterprise interaction channels. In at least one example embodiment, the processing module 202 in conjunction with the instructions of the agent console application 250 (shown in FIG. 2) may be configured to dynamically update all the content portions of the agent console, such that only those content portions relevant to identified/predicted intent are now displayed in the agent console. The agent then may not have to manually sift through the various content portions to identify relevant content portions. The intent-driven engagement facilitated by the agent console is further explained with reference to FIG. 4.

FIG. 4 shows a representation of an agent console 400 for illustrating intent-driven engagement facilitated by the agent console 400, in accordance with an example embodiment. The agent console 400 is depicted to include a chat interaction panel 402. The chat interaction panel is depicted to display an ongoing chat interaction 404 between the agent and a customer ‘JOHN DOE’.

The portion 406 is similar to the portion 300 explained with reference to FIG. 3 and is configured to display information related to the customer ‘John’ along with other information relevant to the chat interaction 404. For example, a widget 408 in the portion 406 depicts name, contact and device information for the customer John along with previous interaction history and preferences for the customer ‘John’. The portion 406 also includes widgets 410 and 412 related to two other ongoing interactions of the agent with customers ‘Peter Anderson’ and ‘Julia Morgan’, respectively.

The identified/predicted intent for the current chat interaction 404 with John is depicted in a header section 414. The identified/predicted intention of the customer ‘John’ is exemplarily depicted to be ‘CANCEL PLAN DUE TO HIGH DATA CHARGES’. The intention of the customer as shown herein may be identified/predicted based on customer activity on enterprise interaction channels. In some embodiments, the intention of the customer may be identified and tagged by agent itself during the course of the chat interaction 404 and thereafter the header section 414 may be caused to display the identified intention.

In at least one example embodiment, the plurality of content portions within the agent console may be dynamically refreshed so as to only reflect content portions relevant to the current chat interaction, i.e. the chat interaction 404. More specifically, various other content portions, such as those related to canned responses, generic recommendations, common workflows, various enterprise application integrations, etc., which are irrelevant to the current chat interaction may be filtered such that only the relevant content portions are retained within the agent console 400. For example, on identification of the intention related to cancellation of plan due to high data charges, only a smart response related to this intention, such as the smart response 416 and a widget related to an enterprise application relevant to the identified intention, such as the widget 420 may be retained within the agent console 400. The widget 420 is associated with a database storing customer information along with customer data plans, and the processing module 202 may be configured to fetch the current data plan of the customer ‘John’ from the database (for example, using API calls or SQL queries) so as to assist the agent in handling queries related to the data plan. Thus, the identified/predicted intention of the customer is used to declutter the content portions in the agent console and provide only the relevant content portions in a handy manner to the agent, thereby enabling the agent to drive the customer engagement based on the identified intention of the customer.

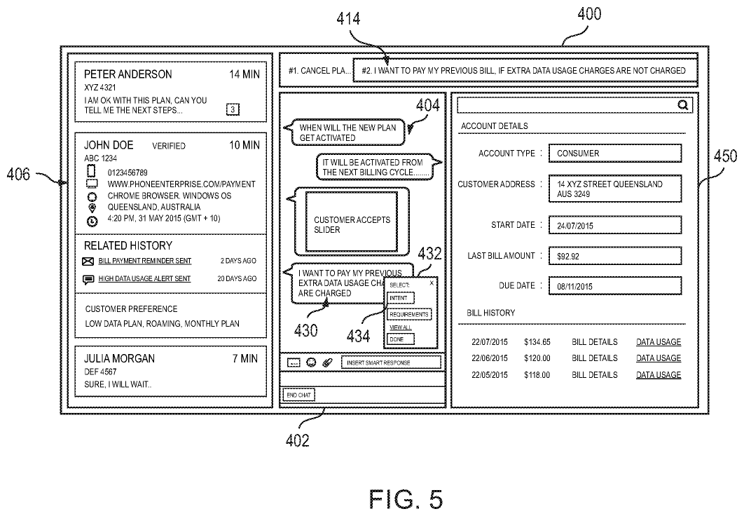

As explained with reference to FIG. 4, the intention of the customer may also be identified and tagged by the agent during the course of the chat interaction. Such tagging of chat content is explained with reference to FIG. 5.

FIG. 5 shows another representation of the agent console 400 of FIG. 4 for illustrating collaborative tagging of chat content by the agent, in accordance with an example embodiment. The portion 406 of the agent console 400 is explained with reference to FIG. 4 and is not explained again herein.

The agent console 400 is depicted to include a chat interaction panel 402. The chat interaction panel is depicted to display an ongoing chat interaction 404 between the agent and a customer ‘JOHN DOE’. The chat interaction 404 is depicted to have progressed from an interim stage depicted in FIG. 4. More specifically, the agent is depicted to have assisted the customer John in acquiring a new data plan. Subsequently, the customer ‘John’ may make another request to the agent. As an illustrative example, the customer ‘John’ has requested assistance in paying a previous bill at 430. As this is a new request, the agent may select the chat line (for example, by clicking or touching on the chat line) to invoke a pop-up 432 showing various options for tagging the chat line. One such option is depicted to be an option 434 showing text ‘INTENT’. The agent may select the option 434 to tag the chat line as intent. Upon tagging of a chat line, the header section 414 is configured to display the second intent, i.e. ‘I WANT TO PAY MY PREVIOUS BILL, IF EXTRA DATA USAGE CHARGES ARE NOT CHARGED’. As explained with reference to FIG. 4, the content portions within the agent console 400 may be dynamically refreshed to only retain those content portions relevant to the chat interaction 404. Accordingly, the widget 420 related to the plans database (shown in FIG. 4) is replaced with a widget 450 associated with a billing application within the agent console 400. The widget 450 is depicted to include billing information for the customer ‘John’ along with history of previous bills. The agent may use the information in the widget 450 to assist the customer.

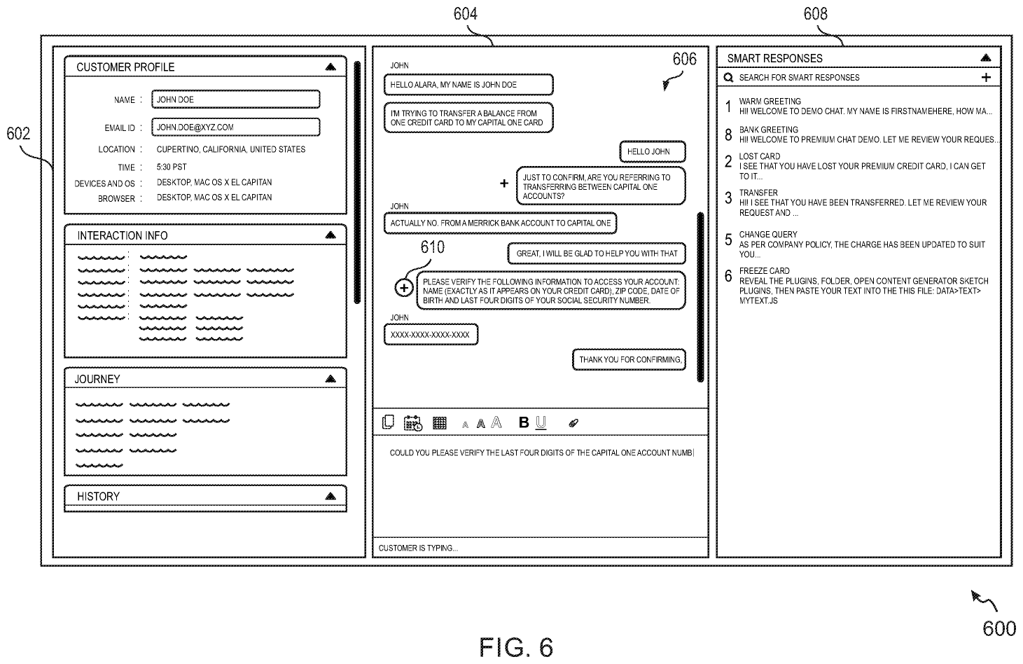

It is noted that the tagging of chat content is not limited to tagging of customer's intention. As an illustrative example, if a customer issue is resolved, then the chat line confirming the resolution may be tagged as ‘Resolution’ by the agent. Similarly, if a chat line corresponds to a workflow step (i.e. a step among a plurality of steps that the agent has to perform for each customer interaction), such as for example, confirming the customer's identity or a step related to seeking customer's acceptance on a recommendation, then one or more chat lines corresponding to such an interaction may be tagged as ‘Workflow’ by the agent. In some cases, the agent may also tag a conversational line as ‘customer profile data’ or ‘product data’. The agent console may also enable the agent to add a response as a smart response, which then can be used for future interactions. The adding of an agent response as a smart response is shown in FIG. 6.

FIG. 6 shows an example representation of an agent console 600 for illustrating an adding of a response as a smart response, in accordance with an example embodiment. The agent console 600 is depicted to include a portion 602, which is configured to provide customer information and relevant context of the interaction to the agent. The portion 602 is similar to the portion 300 explained with reference to FIG. 3 and is not explained again herein. The agent console 600 further includes a chat interaction panel 604 showing a transcript of an ongoing chat interaction 606 between the agent and a customer ‘John Doe’. The agent console 600 further depicts a widget 608 showing a plurality of canned responses (referred to herein as ‘smart responses’). The agent console 600 is configured to enable an agent to add a response during an ongoing chat interaction as a smart response. For example, the agent lines are depicted to be associated with an option 610 (exemplarily depicted as a ‘+’ sign). The agent may select the option 610 to add the response ‘PLEASE VERIFY THE FOLLOWING INFORMATION TO ACCESS YOUR ACCOUNT: NAME (EXACTLY AS IT APPEARS ON YOUR CREDIT CARD), ZIP CODE, DATE OF BIRTH AND LAST FOUR DIGITS OF YOUR SOCIAL SECURITY NUMBER’, as a smart response. The smart response may then be added to the database of smart responses as exemplarily represented by the widget 608.

It is noted that such collaborative tagging of intent, resolution, workflow, responses, etc. provides several advantages. For example, the tagged transcripts of the chat conversations may assist in automatic preparation of wrap-up summaries that the agent have to typically prepare for each chat interaction with a customer. The tagged transcripts may also be used in training automated chat agents (i.e. virtual agents or chat bots) to enable the automated chat agents in handling customer interactions.

As explained above, various embodiments disclosed herein provide numerous advantages. The techniques disclosed herein suggest techniques for facilitating chat interactions between agents and customers of the enterprise. An agent console capable of providing omnichannel interaction context to the agent is disclosed. As a result, the agent is far more equipped to handle customer queries when the chat interaction is initiated. In some cases, proactive invite along with the customer qualifying reason may be passed back to the agent to provide the agent with the necessary context to better assist the customer. Further, the agent console allows the agent to collaboratively tag conversational lines in the chat interaction. In at least one example embodiment, upon identification of the intent, the several content portions of the agent console may dynamically be updated to only display content relevant to the identified intent. As a result, of such dynamic processing of the intent in real-time, the agent is spared the effort of manually sifting through several content portions to identify relevant content. In an illustrative example, workflow steps, canned responses, enterprise integrations, may all be updated as per the intent to assist the agent in engaging with the customer, effectively. Furthermore, using the tagged conversational lines, the agent console may be configured to automatically generate wrap-up dispositions, thereby precluding the agent to prepare a wrap-up summary for each completed chat interaction.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The exemplary embodiments were chosen and described in order to best explain the principles of the present technology and its practical application, to thereby enable others skilled in the art to best utilize the present technology and various embodiments with various modifications as are suited to the particular use contemplated.

1. (canceled)

2. A method comprising:
determining, by a computer system, interaction context from a plurality of enterprise interaction channels;
generating, by the computer system, a predicted intention of an online customer based on the interaction context;
provisioning, by the computer system, a proactive invite to a customer device to initiate an online chat session on an enterprise interaction channel of the plurality of enterprise interaction channels;
enriching, by the computer system, the proactive invite with the predicted intention of the online customer;
transmitting, by the computer system, the proactive invite enriched with the predicted intention to an agent console, responsive to the online chat session being directed to the agent console;
determining, by the computer system, a confidence score for the predicted intention;
comparing, by the computer system, the confidence score to a predefined threshold; and
generating, by the computer system, corresponding automated responses to assist the online customer based on the comparing.

3. The method of claim 2, wherein the interaction context comprises at least one of previous interactions with the customer device, a customer journey of the customer device on the enterprise interaction channel, or a profile of the online customer in a database.

4. The method of claim 2, further comprising:
comparing, by the computer system, the predicted intention of the online customer to an identified intention of the online customer;
analyzing, by the computer system, a success rate of the predicted intention;
storing, by the computer system, the success rate to a database; and
periodically adjusting, by a machine learning module of the computer system, the predefined threshold based on the success rate of the predicted intention.

5. The method of claim 2, wherein determining the confidence score comprises:
analyzing, by the computer system, at least one of previous interactions with the customer device, a customer journey of the customer device on the enterprise interaction channel, or a profile of the online customer from a database; and
providing, by a machine learning module of the computer system, the confidence score based on analysis of the information relating the customer device.

6. The method of claim 2, further comprising:
dynamically updating, by the computer system, the confidence score based on messages from the customer device.

7. The method of claim 2, further comprising:
transmitting, by the computer system, a conversational greeting message to the customer device upon initiation of the online chat session.

8. The method of claim 2, further comprising:
dynamically refreshing, by the computer system, the interaction context based on messages from the customer device; and
providing, by the computer system, the agent console with a real-time context to assist the online customer.

9. The method of claim 2, further comprising:
providing, by the computer system, the agent console with a chat interaction panel; and
displaying, by the computer system, a plurality of content portions based on the interaction context on the agent console.

10. The method of claim 2, further comprising:
generating, by the computer system, wrap-up notes of customer-agent chat interaction; and
storing, by the computer system, the notes to a profile of the online customer in a database for future interactions with the online customer.

11. The method of claim 2, further comprising:
retrieving, by the computer system, wrap-up notes of prior customer-agent chat interaction from a profile of the online customer in a database.

12. A system comprising:
one or more computer processors; and
a computer-readable non-transitory storage medium storing computer instructions, which when executed by the one or more computer processors cause the one or more computer processors to:
determine interaction context from a plurality of enterprise interaction channels;
generate a predicted intention of an online customer based on the interaction context;
provision a proactive invite to a customer device to initiate an online chat session on an enterprise interaction channel of the plurality of enterprise interaction channels;
enrich the proactive invite with the predicted intention of the online customer;
transmit the proactive invite enriched with the predicted intention to an agent console, responsive to the online chat session being directed to the agent console;
determine a confidence score for the predicted intention;
compare the confidence score to a predefined threshold; and
generate corresponding automated responses to assist the online customer based on the comparing.

13. The system of claim 2, wherein the interaction context comprises at least one of previous interactions with the customer device, a customer journey of the customer device on the enterprise interaction channel, or a profile of the online customer in a database.

14. The system of claim 12, wherein the computer instructions, which when executed by the one or more computer processors further cause the one or more computer processors to:
compare the predicted intention of the online customer to an identified intention of the online customer;
analyze a success rate of the predicted intention;
store the success rate to a database; and
periodically adjust, by a machine learning module of the system, the predefined threshold based on the success rate of the predicted intention.

15. The system of claim 12, wherein determining the confidence score comprises:
analyzing at least one of previous interactions with the customer device, a customer journey of the customer device on the enterprise interaction channel, or a profile of the online customer from a database; and
providing, by a machine learning module of the system, the confidence score based on analysis of the information relating the customer device.

16. The system of claim 12, wherein the computer instructions, which when executed by the one or more computer processors further cause the one or more computer processors to:
dynamically update the confidence score based on messages from the customer device.

17. The system of claim 12, wherein the computer instructions, which when executed by the one or more computer processors further cause the one or more computer processors to:
transmit a conversational greeting message to the customer device upon initiation of the online chat session.

18. The system of claim 12, wherein the computer instructions, which when executed by the one or more computer processors further cause the one or more computer processors to:
dynamically refresh the interaction context based on messages from the customer device; and
provide the agent console with a real-time context to assist the online customer.

19. The system of claim 12, wherein the computer instructions, which when executed by the one or more computer processors further cause the one or more computer processors to:
provide the agent console with a chat interaction panel; and
display a plurality of content portions based on the interaction context on the agent console.

20. The system of claim 12, wherein the computer instructions, which when executed by the one or more computer processors further cause the one or more computer processors to:
generate wrap-up notes of customer-agent chat interaction; and
store the notes to a profile of the online customer in a database for future interactions with the online customer.

21. A computer-readable non-transitory storage medium storing computer instructions, which when executed by one or more computer processors cause the one or more computer processors to:
determine interaction context from a plurality of enterprise interaction channels;
generate a predicted intention of an online customer based on the interaction context;
provision a proactive invite to a customer device to initiate an online chat session on an enterprise interaction channel of the plurality of enterprise interaction channels;
enrich the proactive invite with the predicted intention of the online customer;
transmit the proactive invite enriched with the predicted intention to an agent console, responsive to the online chat session being directed to the agent console;
determine a confidence score for the predicted intention;
compare the confidence score to a predefined threshold; and
generate corresponding automated responses to assist the online customer based on the comparing.
